(19) United States
(12) Patent Application Publication
(10) Pub. No.: US 2014/0171145 A1
(43) Pub. Date: Jun. 19, 2014

(54) METHOD AND DEVICE FOR ADJUSTING TRANSMISSION POWER OF MOBILE TERMINAL

(71) Applicants: Zhonghui Che, Shenzhen (CN); Xin Song, Shenzhen (CN); Hongjuan Li, Shenzhen (CN); Leshen Hu, Shenzhen (CN)

(72) Inventors: Zhonghui Che, Shenzhen (CN); Xin Song, Shenzhen (CN); Hongjuan Li, Shenzhen (CN); Leshen Hu, Shenzhen (CN)

(73) Assignee: ZTE CORPORATION, Shenzhen, Guangdong Province (CN)

(21) Appl. No.: 14/239,044

(22) PCT Filed: May 21, 2012
(86) PCT No.: PCT/CN2012/075806

§ 371 Date: Feb. 14, 2014

(30) Foreign Application Priority Data
Aug. 26, 2011 (CN) 201110249234.6

(51) Int. Cl. H04W 52/28; H04W 64/00

(52) U.S. Cl. CPC H04W 52/283; H04W 64/00
USPC 455/522

(57) ABSTRACT

Proposed are a method and device for adjusting transmission power of a mobile terminal. The method includes: a mobile terminal detecting information about a current terminal location according to an operating environment where a user is currently located; obtaining pre-configured power parameter information corresponding to the current terminal location according to the information about the current terminal location and one or more location information transmission power correlation policy tables internally installed in the mobile terminal; and actively adjusting a transmission power parameter according to the obtained pre-configured power parameter information. Compared with the prior art, in the technical solution of the disclosure no additional protocol development needs to be performed on a mobile device, which saves development time, and has better universality and standardization, and can be widely applied to mobile devices which have a universal access function, such as products like mobile phones, UFI type data cards, ROUTERS, etc.

### TECHNICAL FIELD

The disclosure relates to the field of communications, and particularly, to a method and device for adjusting transmission power of a mobile terminal.

### BACKGROUND

With the development of global communication technologies, data services have become an important driving force of the future development of communication technologies, and it can be foreseen that there will be more and more Internet-based data services widely applied in various terminals such as mobile, fixed terminals, etc. Also, the development of the technologies also proposes new demands on the mutual convergence of mobile networks and fixed networks. It is a basic concept for the future networking of mobile operators that the mobile terminal can not only access a mobile network smoothly but also can enjoy bandwidth services provided by the fixed network. For terminals, the UMA (Unlicensed Mobile Access) technology which can access various networks becomes an important function that various mobile terminals have to support in the future. With this technology, the mobile terminal can enable a mobile user to not only enjoy the services of the mobile network but also enjoy the data access services provided by the fixed network. The user uses the convenient network access function provided by the UMA technology to acquire network information, which becomes a preferential function of the user.

According to the conventional implementation, for a mobile terminal having a UMA function, usually, for the sake of the mobility of the user and the long-time use by the user, a battery with a related capacity will be provided so that the radio frequency module always keeps a certain transmission power to meet the electricity consumption requirements of such a terminal. However, how to both realize the maximum electricity saving requirements of the terminal and maximize the user experience of the terminal is an important factor to be taken into account when designing such a terminal, the conventional implementation is to meet the electricity consumption requirements thereof by means of an external power supply, but for users who move frequently, this implementation will affect the user experience, and the other implementations are to reduce radio frequency indexes of related terminals manually, but these products with low indexes result in the problem that the signals are poor in use by the user.

### SUMMARY

In view of the above, the disclosure proposes a method and device for adjusting transmission power of a mobile terminal without any additional protocol development to be performed on a mobile device, which saves the development time, and has better universality and standardization.

The disclosure proposes a method for adjusting transmission power of a mobile terminal, including: a mobile terminal detecting information about a current terminal location according to an operating environment where a user is currently located; obtaining pre-configured power parameter information corresponding to the current terminal location according to the information about the current terminal location and one or more location information transmission power correlation policy tables internally installed in the mobile terminal; and actively adjusting a transmission power parameter according to the obtained pre-configured power parameter information.

Preferably, before the mobile terminal detects the information about the current terminal location according to the operating environment where the user is currently located, the method further includes: after the mobile terminal is powered on, a location information detection functional module internally installed in the mobile terminal starting to capture and detect information about a terminal location at background.

Preferably, detecting the information about the current terminal location is: obtaining a physical location where the mobile terminal is located currently by detecting information output by a GOOGLE MAP API internally installed in the mobile terminal, to complete capturing of the current terminal location.

Preferably, obtaining the pre-configured power parameter information corresponding to the current terminal location according to the information about the current terminal location and the one or more location information transmission power correlation policy tables internally installed in the mobile terminal is: a mobile terminal database management system configuring one or more location information transmission power correlation policy tables, wherein the one or more location information transmission power correlation policy tables are determined according to the number of base stations distributed in a location or network optimization parameter information, and a matching relationship between location information and the pre-configured power parameter information is determined according to related geographical properties; and

obtaining the pre-configured power parameter information corresponding to the current terminal location according to the information about the current terminal location and the one or more location information transmission power correlation policy tables internally installed in the mobile terminal.

Preferably, actively adjusting the transmission power parameter according to the obtained pre-configured power parameter information is: when power transmission data applied by the mobile terminal currently is higher than a pre-configured value, adjusting a non-loss parameter of the mobile terminal to reduce the transmission power of the mobile terminal; and when the current transmission power parameter of the mobile terminal is lower than a pre-configured value, keeping the non-loss parameter of the mobile terminal unchanged to continue to keep low power transmission of the mobile terminal.

The disclosure also proposes a device for adjusting transmission power, wherein the device includes a location information detection module, a power and location information matching module and a power adjustment module, wherein

the location information detection module is configured to detect information about a current terminal location according to an operating environment where a user is currently located;

the power and location information matching module is configured to obtain pre-configured power parameter information corresponding to the current terminal location according to the information about the current terminal location and one or more location information transmission power correlation policy tables internally installed in the mobile terminal and report the obtained pre-configured power parameter information to the power adjustment module; and

the power adjustment module is configured to actively adjust a transmission power parameter according to the pre-configured power parameter information reported by the power and location information matching module.

Preferably, the location information detection functional module is further configured to start to capture and detect the information about a terminal location at background after the mobile terminal is powered on.

Preferably, the location information detection module is configured to detect the information about the current terminal location in the following manner: obtaining a physical location where the mobile terminal is located currently by detecting information output by a GOOGLE MAP API internally installed in the mobile terminal, to complete capturing of the current terminal location.

Preferably, the power and location information matching module is configured to obtain the pre-configured power parameter information corresponding to the current terminal location according to the information about the current terminal location and the one or more location information transmission power correlation policy tables internally installed in the mobile terminal in the following manner:

a mobile terminal database management system configuring one or more location information transmission power correlation policy tables, wherein the one or more location information transmission power correlation policy tables are determined according to the number of base stations distributed in a location or network optimization parameter information, and a matching relationship between location information and the pre-configured power parameter information is determined according to related geographical properties; and

obtaining the pre-configured power parameter information corresponding to the current terminal location according to the information about the current terminal location and the one or more location information transmission power correlation policy tables internally installed in the mobile terminal.

Preferably, the power adjustment is configured to actively adjust the transmission power parameter according to the obtained pre-configured power parameter information in the following manner: when power transmission data applied by the mobile terminal currently is higher than a pre-configured value, adjusting a non-loss parameter of the mobile terminal to reduce the transmission power of the mobile terminal; and when the current transmission power parameter of the mobile terminal is lower than a pre-configured value, keeping the non-loss parameter of the mobile terminal unchanged to continue to keep low power transmission of the mobile terminal.

In summary, the application of the above solution has the following beneficial effects:

compared with the prior art, in the technical solution of the disclosure, not only the deficiencies of the conventional implementation are avoided but also no additional protocol development needs to be performed on a mobile device, which saves development time, has better universality and standardization, and can be widely applied to mobile devices which have a universal access function, such as products like mobile phones, UFI type data cards, ROUTERS, etc.

### BRIEF DESCRIPTION OF THE DRAWINGS

FIG. 1 is a schematic diagram of a device for adjusting transmission power of a mobile terminal in an embodiment of the disclosure; and

FIG. 2 is a schematic flowchart of a method for adjusting transmission power of a mobile terminal in an embodiment of the disclosure.

### DETAILED DESCRIPTION OF THE EMBODIMENTS

The disclosure proposes a method and device for adjusting transmission power of a mobile terminal.

The basic concept of the embodiments of the disclosure includes: a mobile terminal actively detects information about a current terminal location according to an operating environment where a user is currently located, obtains pre-configured power parameter information corresponding to the current terminal location according to the properties of the information about the current terminal location and one or more location information transmission power correlation policy tables internally installed in the mobile terminal, and actively adjusts a transmission power parameter according to the obtained pre-configured power parameter information. As such, the requirements to the mobile terminal that not only proper wireless transmission can be provided but also the standby time of the mobile terminal is prolonged are met.

In the embodiments of the disclosure, the device for adjusting transmission power can actively detect the location information where the mobile terminal is located currently, perform matching according to the detected location information and one or more location information transmission power correlation policy tables stored in the terminal, and adjust the wireless coverage distance of a mobile terminal according to the matching relationship, thereby realizing the dynamic adjustment of the transmission power of the mobile terminal, and thus realizing the energy-saving of the mobile terminal.

The mobile terminal stores one or more location information transmission power correlation policy tables in the database thereof. If the user moves to the suburb, when the user performs a telephone or data service, the transmission power can be increased so as to obtain the surrounding network as far as possible, while at a place where the signals are predicted to be good, the transmission power can be reduced. A location information detection and judgment module is a main unit for performing this database operation.

By way of capturing terminal location information and realizing the adjustment of the transmission power of the terminal using the location information and one or more location information transmission power correlation policy tables that are internally installed, the transmission power can be placed in a lower state under the condition that the surrounding carrier of the mobile terminal can bear wireless signals.

A wireless power adjustment and switching module realizes the adjustment and switching of the wireless transmission power of the mobile terminal according to the related detection result of the detection module and user setting detection, thus realizing the function of dynamically adjusting the transmission power of the mobile terminal.

Hereinafter, the preferred embodiments of the disclosure will be described in conjunction with the drawings, and it should be understood that the preferred embodiments described here are merely used for describing and explaining the embodiments of the disclosure and not used to limit the disclosure.

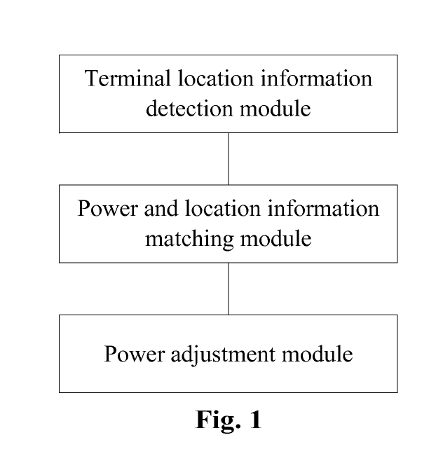

FIG. 1 is a schematic diagram of a device for adjusting transmission power of a mobile terminal in an embodiment of the disclosure. As shown in FIG. 1, the device includes a location information detection module, a power and location information matching module and a power adjustment module.

The location information detection module is configured to detect information about a current terminal location according to an operating environment where a user is currently located and report the information about the current terminal location to the power and location information matching module.

The power and location information matching module is configured to obtain pre-configured power parameter information corresponding to the current terminal location according to the information about the current terminal location and one or more location information transmission power correlation policy tables internally installed in the mobile terminal and report the obtained pre-configured power parameter information to the power adjustment module.

The power adjustment module is configured to actively adjust a transmission power parameter according to the pre-configured power parameter information reported by the power and location information matching module. The matching module actively sets application parameter information of the environment where a related terminal is located according to surrounding environment information of the terminal and adjusts the level of the transmission power of the terminal according to related parameter information, thus not only being able to meet the transmission power requirements of the mobile terminal but also being able to improve the use experience of the mobile terminal.

If the mobile terminal is in a remote area and there are fewer base stations in the surrounding, when the user performs a telephone or data service, the transmission power can be allowed to increase to realize maximum coverage; and if the mobile terminal is at a place where the surrounding signals are sufficient, the transmission power needs to be reduced to improve the using duration of the battery of the mobile terminal.

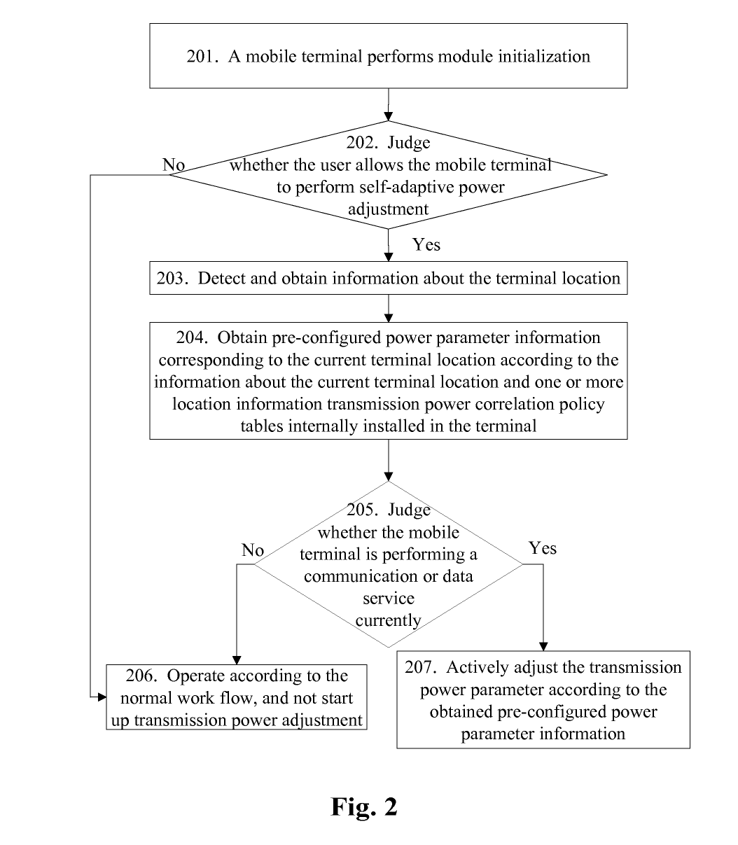

FIG. 2 is a schematic flowchart of a method for adjusting transmission power of a mobile terminal in an embodiment of the disclosure. As shown in FIG. 2, the method includes the following steps.

In Step S201, a mobile terminal performs module initialization;

specifically, after the mobile terminal is powered on, the initialization of the mobile terminal is completed, and a location information detection functional module internally installed in the mobile terminal starts to capture and detect information about a terminal location at background.

In Step S202, it is judged whether the user allows the mobile terminal to perform self-adaptive power adjustment; if yes, proceed to Step S203, otherwise, proceed to Step S206.

In Step S203: information about the terminal location is detected and obtained;

specifically, after being powered on and starting running, the mobile terminal actively captures network information. A Google Map API (Application Programming Interface) is internally installed in the mobile terminal, and the physical location where the terminal is located currently can be obtained by detecting the information output by the API. In this way, the capturing of the current terminal location is completed.

For the capturing of the terminal location, except GOOGLE MAP API, for a mobile terminal which has a GPS or a location detection function, the current terminal location can also be obtained using related location detection methods.

In Step S204: pre-configured power parameter information corresponding to the current terminal location is obtained according to the information about the current terminal location and one or more location information transmission power correlation policy tables internally installed in the terminal;

specifically, a mobile terminal database management system configures one or more location information transmission power correlation policy tables, wherein the one or more location information transmission power correlation policy tables are determined according to the number of base stations distributed in the location or network optimization parameter information, i.e., the matching relationship between the location information and pre-configured power parameter information can be determined according to related geographical properties; and

the pre-configured power parameter information corresponding to the current terminal location is obtained according to the information about the current terminal location and the one or more location information transmission power correlation policy tables internally installed in the terminal.

In Step S205, it is judged whether the mobile terminal is performing a communication or data service currently, and if yes, proceed to Step S207, otherwise, proceed to Step S206.

In Step S206: the terminal operates according to the normal work flow, and does not start up transmission power adjustment.

In Step S207: the transmission power parameter is actively adjusted according to the obtained pre-configured power parameter information;

specifically, if power transmission data currently applied by the mobile terminal is higher than a pre-configured value, then a non-loss parameter of the mobile terminal is adjusted so as to reduce the transmission power of the mobile terminal; and if the current power transmission data of the mobile terminal is lower than a pre-configured value, then the non-loss parameter of the mobile terminal keeps unchanged so as to continue to keep the low power transmission of the mobile terminal.

An embodiment of the disclosure also provided a mobile terminal for applying the above-mentioned method. In the method and mobile terminal in the embodiments of the disclosure, since the transmission power is adjusted dynamically, the matching relationship table is detected only when the mobile terminal is dialing or performing a data service which is set by the user, and therefore the standby current of the mobile terminal will not be increased, which ensures that no additional power consumption is generated for the normal working of the mobile terminal.

Compared to the prior art, in the embodiments of the disclosure, not only the deficiencies of the conventional implementation are avoided but also no additional protocol development needs to be performed on a mobile device, which saves development time, has better universality and standardization, and can be widely applied to mobile devices which have a universal access function, such as products like mobile phones, UFI type data cards, ROUTERS, etc.

Of course, the disclosure can have may implementations, and without departing from the principle and essence of the disclosure, those skilled in the art certainly can make various corresponding changes or alterations according to the disclosure, and any modifications, equivalents and improvements made within the principle of the disclosure shall be contained in the scope of protection of the disclosure.

1. A method for adjusting transmission power of a mobile terminal, comprising:
a mobile terminal detecting information about a current terminal location according to an operating environment where a user is currently located; obtaining pre-configured power parameter information corresponding to the current terminal location according to the information about the current terminal location and one or more location information transmission power correlation policy tables internally installed in the mobile terminal; and actively adjusting a transmission power parameter according to the obtained pre-configured power parameter information.

2. The method as claimed in claim 1, wherein before the mobile terminal detects the information about the current terminal location according to the operating environment where the user is currently located, the method further comprises:
after the mobile terminal is powered on, a location information detection module internally installed in the mobile terminal starting to capture and detect information about a terminal location at background.

3. The method as claimed in claim 2, wherein detecting the information about the current terminal location comprises: obtaining a physical location where the mobile terminal is located currently by detecting information output by a GOOGLE MAP Application Programming Interface (API) internally installed in the mobile terminal, to complete capturing of the current terminal location.

4. The method as claimed in claim 1, wherein obtaining the pre-configured power parameter information corresponding to the current terminal location according to the information about the current terminal location and the one or more location information transmission power correlation policy tables internally installed in the mobile terminal comprises:
a mobile terminal database management system configuring one or more location information transmission power correlation policy tables, wherein the one or more location information transmission power correlation policy tables are determined according to the number of base stations distributed in a location or network optimization parameter information, and a matching relationship between location information and the pre-configured power parameter information is determined according to related geographical properties; and
obtaining the pre-configured power parameter information corresponding to the current terminal location according to the information about the current terminal location and the one or more location information transmission power correlation policy tables internally installed in the mobile terminal.

5. The method as claimed in claim 1, wherein actively adjusting the transmission power parameter according to the obtained pre-configured power parameter information comprises: when power transmission data applied by the mobile terminal currently is higher than a pre-configured value, adjusting a non-loss parameter of the mobile terminal to reduce the transmission power of the mobile terminal; and when the current transmission power parameter of the mobile terminal is lower than a pre-configured value, keeping the non-loss parameter of the mobile terminal unchanged to continue to keep low power transmission of the mobile terminal.

6. A device for adjusting transmission power, comprising a location information detection module, a power and location information matching module, and a power adjustment module, wherein:
the location information detection module is configured to detect information about a current terminal location according to an operating environment where a user is currently located;
the power and location information matching module is configured to obtain pre-configured power parameter information corresponding to the current terminal location according to the information about the current terminal location and one or more location information transmission power correlation policy tables internally installed in the mobile terminal and report the obtained pre-configured power parameter information to the power adjustment module; and
the power adjustment module is configured to actively adjust a transmission power parameter according to the pre-configured power parameter information reported by the power and location information matching module.

7. The device as claimed in claim 6, wherein the location information detection module is further configured to start to capture and detect the information about a terminal location at background after the mobile terminal is powered on.

8. The device as claimed in claim 6, wherein the location information detection module is configured to detect the information about the current terminal location in the following manner:
obtaining a physical location where the mobile terminal is located currently by detecting information output by a GOOGLE MAP Application Programming Interface (API) internally installed in the mobile terminal, to complete capturing of the current terminal location.

9. The device as claimed in claim 6, wherein the power and location information matching module is configured to obtain the pre-configured power parameter information corresponding to the current terminal location according to the information about the current terminal location and the one or more location information transmission power correlation policy tables internally installed in the mobile terminal in the following manner:
a mobile terminal database management system configuring one or more location information transmission power correlation policy tables, wherein the one or more location information transmission power correlation policy tables are determined according to the number of base stations distributed in a location or network optimization parameter information, and a matching relationship between location information and the pre-configured power parameter information is determined according to related geographical properties; and
obtaining the pre-configured power parameter information corresponding to the current terminal location according to the information about the current terminal location and the one or more location information transmission power correlation policy tables internally installed in the mobile terminal.

10. The device as claimed in claim 6, wherein the power adjustment is configured to actively adjust the transmission power parameter according to the obtained pre-configured power parameter information in the following manner: when power transmission data applied by the mobile terminal currently is higher than a pre-configured value, adjusting a non-loss parameter of the mobile terminal to reduce the transmission power of the mobile terminal; and when the current transmission power parameter of the mobile terminal is lower than a pre-configured value, keeping the non-loss parameter of the mobile terminal unchanged to continue to keep low power transmission of the mobile terminal.
